(19) United States
(12) Patent Application Publication
(10) Pub. No.: US 2015/0370931 A1
(43) Pub. Date: Dec. 24, 2015

(54) REDUCING THE DATA RATE OF COMPRESSIVE MEASUREMENT BY USING LINEAR PREDICTION

(71) Applicant: ALCATEL-LUCENT USA INC., Murray Hill, NJ (US)

(72) Inventor: Raziel Haimi-Cohen, Springfield, NJ (US)

(73) Assignee: ALCATEL-LUCENT USA INC.

(21) Appl. No.: 14/310,548

(22) Filed: Jun. 20, 2014

(51) Int. Cl. G06F 17/50; G06F 17/18; G06F 17/16

(52) U.S. Cl. CPC G06F 17/5009; G06F 17/16; G06F 17/18

(57) ABSTRACT

Various embodiments relate to a non-transitory machine-readable storage medium encoded with instructions for execution by a source device for compressive sensing a signal, wherein the source device acquires a set of compressive sensing measurements using a structured sensing matrix, the non-transitory machine-readable medium including: instructions for determining a signal specific coding scheme for the set of compressive sensing measurements; instructions for coding the compressed sensing measurements using the determined signal specific coding scheme; instructions for determining a parametric model describing the signal specific coding scheme for the encoded set of compressed sensing measurements; and instructions for transmitting a description of the parametric model to via a communications channel.

### TECHNICAL FIELD

Various exemplary embodiments disclosed herein relate generally to reducing the data rate of compressive measurement by using linear prediction.

### BACKGROUND

Compressed sensing is an emerging technology that acquires, compresses and transmits a set of measurements that represent some sort of data signal. The essence of compressed sensing is to represent a data signal by using compressive measurements. Compressed sensing may be used when the data signal to be measured has a sparse representation in some domain. For example, the data signal may include a small number of frequency components. In such situations, compressed sensing may reduce the number of measurements needed beyond that specified by Nyquist sampling. The compressive measurements are obtained by applying a measurement matrix to the data signal to be represented. The original data signal may then be reconstructed by solving an underdetermined set of linear equations along with the constraint that the data signal is sparse.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a non-transitory machine-readable storage medium encoded with instructions for execution by a source device for compressive sensing a signal, wherein the source device acquires a set of compressive sensing measurements using a structured sensing matrix, the non-transitory machine-readable medium including: instructions for determining a signal specific coding scheme for the set of compressive sensing measurements; instructions for coding the compressed sensing measurements using the determined signal specific coding scheme; instructions for determining a parametric model describing the signal specific coding scheme for the encoded set of compressed sensing measurements; and instructions for transmitting a description of the parametric model to via a communications channel.

Various embodiments are described wherein the signal specific coding scheme is not identical for all the measurements in the set of compressive sensing measurements.

Various embodiments are described wherein the coding scheme includes quantizing the compressed sensing measurements.

Various embodiments are described wherein the quantizing of the compressive sensing measurements is done differently for different subsets of the set of compressive sensing measurements.

Various embodiments are described wherein the coding scheme includes using a prediction of at least one compressed sensing measurement and a residual to describe the compressed sensing measurements.

Various embodiments are described wherein the description of the parametric model includes a description of the prediction coefficients.

Various embodiments are described wherein determining a signal specific coding scheme for the set of compressed sensing measurements further includes: instructions for computing prediction coefficients for the at least one measurement based upon statistical properties of the signal; wherein the parametric model describing the signal specific coding scheme determines the prediction coefficients.

Various embodiments are described wherein the coding the compressed sensing measurements using the determined signal specific coding scheme includes coding of a prediction residual for at least one measurement.

Further, various exemplary embodiments relate to a non-transitory machine-readable storage medium encoded with instructions for execution by a destination device for decoding compressive sensing measurements, the non-transitory machine-readable medium including: instructions for receiving a set of encoded compressive sensing measurements of the signal; instructions for receiving a parametric model describing a signal specific coding scheme for the encoded set of compressed sensing measurements; and instructions for decoding the compressed sensing measurements using the signal specific coding scheme described by the received parametric model.

Various embodiments are described further including: instructions for reconstructing a signal from the decoded compressive sensing measurements.

Various embodiments are described wherein the signal specific coding scheme is not identical for all the measurements in the set of compressive sensing measurements.

Various embodiments are described wherein the set of encoded compressive sensing measurements includes codewords of quantized compressive sensing measurements.

Various embodiments are described wherein the coding scheme includes using a prediction of at least one compressed sensing measurement.

Various embodiments are described wherein the set of encoded compressive sensing measurements measurement includes a prediction residual.

Further, various exemplary embodiments relate to a source device including: a memory device; and a processor in communication with the memory device, the processor being configured to: acquire a set of compressive sensing measurements of the signal using a structured sensing matrix; determine a signal specific coding scheme for the set of compressive sensing measurements; code the compressed sensing measurements using the determined signal specific coding scheme; determine a parametric model describing the signal specific coding scheme for the encoded set of compressed sensing measurements; and transmit a description of the parametric model to via a communications channel.

Various embodiments are described wherein the signal specific coding scheme is not identical for all the measurements in the set of compressive sensing measurements.

Various embodiments are described wherein the coding scheme includes quantizing the compressed sensing measurements.

Various embodiments are described wherein the quantizing of the compressive sensing measurements is done differently for different subsets of the set of compressive sensing measurements, based upon the statistical properties of the compressive sensing measurements.

Various embodiments are described wherein the coding scheme includes using a prediction of at least one compressed sensing measurement and a residual to describe the compressed sensing measurements.

Various embodiments are described wherein the description of the parametric model includes a description of the prediction coefficients.

Various embodiments are described wherein determining a signal specific coding scheme for the set of compressed sensing measurements further includes: computing prediction coefficients for the at least one measurement based upon statistical properties of the signal; wherein the parametric model describing the signal specific coding scheme determines the prediction coefficients.

Various embodiments are described wherein the coding the compressed sensing measurements using the determined signal specific coding scheme including coding of a prediction residual for at least one measurement.

Further, various exemplary embodiments relate to a destination device including: a memory device; and a processor in communication with the memory device, the processor being configured to: receive an encoded set of compressive sensing measurements of the signal; receive a parametric model describing a signal specific coding scheme for the encoded set of compressed sensing measurements; and decode the compressed sensing measurements using the signal specific coding scheme described by the received parametric model.

Various embodiments are described further including the step of: reconstructing a signal from the decoded compressive sensing measurements.

Various embodiments are described wherein the signal specific coding scheme is not identical for all the measurements in the set of compressive sensing measurements.

Various embodiments are described wherein the encoded set of compressive sensing measurements includes codewords of quantized compressive sensing measurements.

Various embodiments are described wherein the coding scheme includes using a prediction of at least one compressed sensing measurement.

Various embodiments are described wherein the encoded set of compressive sensing measurements measurement includes a prediction residual.

### BRIEF DESCRIPTION OF THE DRAWINGS

In order to better understand various exemplary embodiments, reference is made to the accompanying drawings, wherein:

FIG. 1 illustrates a communication system using compressed measurements to transmit a signal;

FIG. 2 illustrates an exemplary hardware diagram for implementing a source device, destination device, or any of the specific parts or groups of parts of either of these devices;

FIG. 3 illustrates method of encoding and transmitting compressed sensing measurements of a signal by a source device; and

FIG. 4 illustrates method of receiving and reconstructing compressed sensing measurements of a signal by a destination device.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., or), unless otherwise indicated (e.g., “or else” or “or in the alternative”). Additionally, the various embodiments described herein are not necessarily mutually exclusive and may be combined to produce additional embodiments that incorporate the principles described herein.

Compressed sensing (CS) is a method for compressing a signal (e.g. a video or a picture) by a small set of measurements, each measurement being a quantity, such that the signal can be reconstructed from the measurements. Compressed sensing may be used when the signal to be compressed has a sparse representation in some domain. The measurements are obtained by linear operations on the signal. Suppose the signal is a vector of order N. Compressed sensing is often used for transmission, where the measurements are generated at one place (the transmitter) sent over a channel and then received by a receiver which reconstructs the original signal. If the measurements are transmitted via a communication channel, they are quantized into codewords and the codewords are transmitted using some form of channel coding. Quantization introduces some distortion in the quantized measurements. The goal of the quantization and channel coding is to minimize the data rate, i.e. the number of bits required for the transmission of each measurement, while keeping the distortion at a certain level, or equivalently, to minimize the distortion while keeping the data rate at a certain level.

Below a more detailed description is given of embodiments of methods and systems for compressed sensing.

Compressed sensing is concerned with determining a signal xε [symbol] ⁿ from a vector of measurements,

y=Φx (1)

where Φε [symbol] ^{m×n}, m<<n is a sensing matrix, and x is [symbol] -sparse representation in the column space of a sparsifying matrix Ψ,

x=Ψζ, ∥ζ∥₀≦k, (2)

where Ψ is an orthogonal or a tight frame matrix and ∥ζ∥₀ denotes the number of non-zero entries in ζ. If ΦΨ meets certain conditions, ζζ, and consequently x, can be reconstructed from the measurements by solving the constrained minimization problem

min∥ζ∥₁ s.t. y=ΦΨζ (3)

Other results in the same vein extend the results to compressible signals (signals which can be approximated by sparse signals), or provide error bounds on the reconstructed solution when the measurements contain noise.

As a data compression method, compressed sensing has some unique features. For example, the same measurements vector can be used by different recovery algorithms and different sparsifiers. Moreover, successful signal recovery is possible even if some measurements are lost. In addition, the balance of complexity between compression and reconstruction is sharply skewed towards the latter. While the right hand side of (1) is a simple linear operation, signal reconstruction requires solving a constrained minimization such as in (3). These properties make compressed sensing attractive for applications such as video transmission over lossy channels, video transmission where the same signal may be decoded by different types of receivers and video surveillance applications, where only a small part of the video stream needs to be reconstructed. In all these applications the transmission of measurements requires a coding scheme, which entails source coding, typically by quantizing measurements into codewords, followed by channel coding of the quantization codewords.

A goal of the embodiments described herein is to reduce the data rate needed for transmitting the codewords over a communication channel by leveraging knowledge about the statistics of the measurements. This may be done because it has been found that with a certain type of sensing matrices, different measurements have different variances or there is significance correlation among measurements. The communication channel may be a wired or wireless link or it can be a storage medium into which the transmitter writes the measurements, and possibly related data, and from which the receiver reads the measurements, and possibly related data.

Two different exemplary embodiments are presented herein. First, different quantizer settings may be used for each measurement, based on each measurement's standard deviation or other statistical characteristics. In our examples the quantizer is a scalar uniform quantizer and the step size of the quantizer is proportional to the each measurement's standard deviation. Therefore, if the measurements have different standard deviations, the quantizer for each measurement uses a different step size, based on the standard deviation of the specific measurement. Similar methods may be applied using other statistical properties of the measurements or other types of quantizers. Second, statistical dependence among measurements gives rise to the prediction of the values of some measurements based on the values of other measurements. Let r>0 be a fixed integer (for simplicity assume r|m) and let the measurements y₁, . . . , yₘ be grouped in m/r sets {y₁ₚ, . . . , yᵣₚ}, 1≦p≦n/r such that the r members of each set are significantly correlated. For 1≦q≦r, 1≦p≦n/r, let a_{h,q,p}, 1≦h<q be the linear prediction coefficients which minimize var{u_{qp}}, where the residual u_{qp} is defined by

u_{qp} [symbol] (y_{qp}−E{y_{qp}})−Σₕ₌₁^{q-1}a_{h,q,p}(yₕₚ−E{yₕₚ}) (4)

{u₁ₚ, . . . , u_{qp}}, are zero mean, uncorrelated and

var{u_{qp}}=var{z_{qp}})−Σₕ₌₁^{q-1}a_{h,q,p}cov(yₕₚ,y_{qp}). (5)

where cov(yₖₚ, yₗₚ) is the covariance between the measurements yₖₚ, yₗₚ), 1≦k,l≦q and the prediciton coefficients a_{h,q,p}, 1≦h<q are selected so that var{u_{qp}} is minimal. Therefore, if any of the covarinaces in the right hand side of (5) is non-zero, var{u_{qp}}<var{z_{qp}}, quantizing u_{qp} instead of yₕₚ results in a lower data rate. As is well known, a_{h,q,p}, 1≦h<q are the solution of a set of q−1 linear equations whose coefficients are derived from the covariances of the measurements. If the measurements are highly dependent, the prediction error, also known as the residual, has a much lower energy, and can be encoded at a much lower data rate, than the original predicted measurement. In this case, it is possible to reduce the data rate by quantizing and transmitting the residual instead of the actual measurement. In the following we describe linear prediction, which is based on correlation among measurements, but similar methods may be applied to non-linear prediction, which may be based on other statistical properties.

In order to decode measurements which have been encoded in the methods described above, the decoder needs to “know” the settings of the encoder, for example, the step size of the quantizer or the linear prediction coefficients. Since these settings are signal-dependent, they cannot be provisioned in the decoder in advance. Therefore, these settings need to be transmitted to the receiver as side information. Consequently, in order to achieve a substantial data rate reduction which justifies the added complexity, the data rate needed for transmitting the side information must be substantially lower than the data rate reduction in the measurements' data rate which results from the application of these methods. This precludes direct transmission of the encoder's settings, as the data rate requires for transmitting a step size for each measurement is similar to the data rate needed for transmitting the measurements themselves. A non-parametric approximation is also not useful in general. For example, suppose we grouped the measurements based on similarity of their standard deviation, and for each measurement the quantizer step size was made proportional to the mean of the standard deviations of all measurements in the same group. In this case, the number of step sizes that needed to be transmitted would be the number of groups. However, using approximate standard deviations would attain less reduction in the data rate of the measurements, and, more importantly, would require transmitting, for each measurement, the index of the group to which the measurement belongs. Therefore, the data rate of the side information would grow linearly with the number of measurements, thus making it too large to achieve any significant overall gain in data rate.

The embodiments described herein show ways to represent the statistical information that determines the settings of the encoder by a parametric model that is determined by a small number of parameters, which may be estimated from the input signal. Therefore, these few parameters, whose number is fixed and not dependent on the number of measurements, are the only side information that needs to be transmitted in order to enable the receiver to compute the information necessary to decode the measurements. In some cases the parametric model provides only an approximation to the actual statistical information that which is necessary for determining the encoder settings. In this case, the encoder should use the approximate statistical information, in order that the encoder and decoder will be matched.

We define a sensing matrix to be structured if the measurements it produces have signal-specific statistics which can be represented by a parametric model.

In the following exemplary sensing matrices are shown, which are structured and which produce measurements such either the measurements have different standard deviations and the ratios of standard deviations of different measurements is signal-specific; or some measurement are correlated and the correlation coefficients are signal-specific.

In this discussion it is assumed that this operation of measurement generation, as defined in (1), is done digitally by using a digital computer or a similar device. However, some embodiments may generate the measurements using linear operation in the analog domain, where the matrix multiplication is implemented by manipulation of physical quantities. The invention is equally applicable in both digital and analog implementation.

Various design methods attempt to generate a sensing matrix Φ which guarantees a correct solution (exact or approximate) with a small number of measurements. It is impossible for a single sensing matrix to achieve this goal for every possible sparsifying matrix Ψ, because if any column of Ψ is in the non-trivial null space of Φ, there is a non-zero, 1-sparse ζ for which ΦΨζ=0. However, some probabilistic design methods guarantee a correct solution, with very high probability for any given Ψ. This property, called universality, is highly desired because it allows deferring the determination of Ψ to the reconstruction phase. Another design goal, which is essential for large scale applications, is low computational complexity of matrix operations with Ψ.

A fully random matrix (FRM) is a matrix whose entries are independent, identically distributed (IID) Gaussian or Bernoulli random variables (RVs). FRMs are universal and require relatively few measurements: If m≧O(k log(n/k)), then for any given sparsity matrix Ψ the signal can be reconstructed with very high probability. However, because of their completely unstructured nature, FRMs are computationally unwieldy in large scale applications.

The computational complexity problem may be addressed by using sensing matrices generated by deterministic methods, which are clearly not universal. Another approach is to impose structural constraints on the randomness such as in the use of randomly sampled transforms (RST)

Φ=\sqrt{n/m}SW (6)

where Wε [symbol] ^{n×n} an orthonormal matrix having a fast transform, such as the Walsh Hadamard Transform (WHT), the Discrete Cosine Transform (DCT) or the Discrete Fourier Transform (DFT), and Sε [symbol] ^{m×n} a matrix whose rows are selected randomly, with uniform distribution, from the rows of Iₙ, the n×n identity matrix. Φx can be computed efficiently by calculating the fast transform Wx and selecting a subset of the transform coefficients. The number of measurements needed with RSTs is determined by the mutual coherence of Φ and Ψ,

$$μ ( Φ , Ψ ) {=}^{Δ} \sqrt{n} {max}_{1 \leq i \leq m , 1 \leq j \leq n} \vert {f}_{i} {ψ}_{j} \vert / ( {‖ {f}_{i} ‖}_{2} {‖ {ψ}_{j} ‖}_{2} ) .$$

where fᵢ and ψⱼ are the ith row and jth column of Φ and Ψ, respectively. RSTs guarantee a correct solution, with very high probability, if m≧O(μ² (W,Ψ)k log n). Because 1≦μ(W,Ψ)≦\sqrt{n}, a correct solution with m<<n is guaranteed, with high probability, only if W and Ψ are mutually incoherent, that is, if μ(W,Ψ)≈1. On the other extreme, if μ(W,Ψ)=\sqrt{n} there is a column of Ψ which is a scalar multiple of a row of W and therefore orthogonal to all the other rows of W. If m<<n, then with high probability that row is not selected by S and the corresponding column is in the null space of Φ. Therefore, RSTs also are not universal.

The universality issue was addressed by the introduction of structurally random matrices (SRM):

Φ=\sqrt{n/m}SWR (7)

where S,W are as above and Rε [symbol] ^{n×n}, an orthonormal random matrix. Hence

Φx=\sqrt{n/m}SW(Rx)=\sqrt{n/m}SW(RΨ)ζ.

Therefore, a SRM with a given sparsifier Ψ behave as the RST \sqrt{n/m}SW with the random sparsifier RΨ. If RΨ and W are mutually incoherent with very high probability, then SRMs are universal and the known results for RSTs with incoherent sparsifying matrices (e.g. performance with compressible signals or noisy measurements) can be directly applied to them.

SRMs are computationally simple and have been shown, under certain mild assumptions, to make the SRM incoherent with any given sparsifying matrix with very high probability. Although in the discussion herein it is assumed that both signal and measurements are real, the matrices W and R may be complex, as long as their product is real.

If Φ in eq. (1) is SRM, that equation can be written as

z [symbol] \sqrt{n/m}WRx (8)

yₖ=z_{c(k)} (9)

where the measurements indices cₙ(k), k=1, . . . , m are the indices of the rows of Iₙ that have been selected in S. cₙ(k), k=1, . . . , m are RVs uniformly distributed in [symbol] ₙ. Therefore, each of y₁, . . . , yₘ is a mixture, with equal probabilities, of the mixture components z₁, . . . , zₙ, hence y₁⁽ⁿ⁾, . . . , yₘ⁽ⁿ⁾ are identically distributed. Furthermore, if cₙ(k), k=1, . . . , m are selected from [symbol] ₙ with replacement, or if m<<n, it can be shown that y₁, . . . , yₘ are approximately independent RVs. Accordingly, it appears that the same method quantization and channel coding may be applied to all measurements. This conclusion, however, is based on considering the measurement indices as random variables. For a given sequence of measurement indices, that is, for a specific, deterministic sequence cₙ(k)ε [symbol] ₙ, k=1, . . . , m, (which is known at both encoder and decoder), the distribution of any measurement yₖ is the distribution of the specific mixture component z_{c(k)}. If the distributions of z₁, . . . , zₙ are different, a lower distortion at the same data rate can be achieved by adapting the coding scheme for each of yₖ, 1≦k≦m to the distribution of z_{c(k)}, the particular mixture component assigned to yₖ. Furthermore, if z₁, . . . zₙ are correlated, linear prediction may be used before quantization to remove the redundancy in the measurements, as specified by (4), with each measurement yₕₚ replaced by the corresponding mixture component.

The values of the covariances of the mixture components depend on the type of SRM. There are several types of SRMs, which are determined by the type of the random matrix R and the selected transform W. Some of them are described in more detail below. It is also shown that the covariances of the mixture components of these types of SRMs can be represented with a small number of parameters, therefore, by (9), these SRMs are structured.

In local randomization SRM (LR-SRM), R is a diagonal matrix whose entries are IID RVs which gets the values ±1 with equal probabilities, thus the sign of each entry of x is randomly toggled before the fast transform W is applied. With LR-SRMs each mixture component has zero mean, and the covariance of the mixture components is given by

$$cov \{ {z}_{j} , {z}_{h} \} = \frac{n}{m} {\sum }_{k = 1}^{n} {w}_{jk} {w}_{hk} {x}_{k}^{2} = \frac{n}{m} ( {w}_{j} ∘ {w}_{h} ) ( x ∘ x ) \qquad ( 10 )$$

where wⱼₖ is the (j,k) element in W, wⱼ is the jth row of W, and ∘ denotes entrywise product, thus, for example, wⱼ∘wₕ=[wⱼ₁wₕ₁, . . . , wⱼₙwₕₙ]. If the signal is not constant, the mixture components are correlated, that is, there are pairs (zⱼ,zₕ), 1≦j≠h≦n such that cov{zⱼ,zₕ}≠0, hence in linear prediction as given by (10), the variance of the residual is smaller than the variance of the original signal. Furthermore, with DCT and DFT, the variance of the mixture components, var{zⱼ}=cov{zⱼ,zⱼ} is in general not the same because in with the DCT and DFT transforms wⱼ∘wⱼ is not constant.

x∘x=[x₁², . . . xₙ²]^{T} is the entrywise square of the original signal and X [symbol] W(x∘x) is the transform W applied to the entrywise square of the original signal. If W is one of the commonly used transforms WHT, DCT or DFT, this equation can be simplified because the entrywise product of two rows, wⱼ∘wₕ, is a simple linear combination of a very small number other rows:

wⱼ∘wₕ=n^{-1/2}Σₖ₌₁^{p}γₖ(j,h)wₗ_{ₖ}_{(j,h)}.

For the WHT p=1, γₖ(j,h)=1, and l₁(j,h) is computed using bitwise modulo-2 addition on the binary representations of j and h. Thus any pointwise product of two rows can be represented by a single other row, wⱼ∘wₕ=n^{-1/2}wₗ_{ₖ}_{(j,h)}. For the DCT and DFT, because of the well known formulae for products of sines and cosines, p=2, γₖ(j,h)=±1 and lₖ(j,h), k=1, 2 correspond to frequencies which are sums or differences of the frequencies of j and h. Hence in these cases, wⱼ∘wₕ=n^{-1/2}[±wₗ_{₁}_{(j,h)}±wₗ_{₂}_{(j,h)}]. Therefore, if W is one of the transforms WHT, DCT or DFT:

cov(yⱼ,yₕ)=cov(z_{c(j)},z_{c(h)})=(n^{-1/2}/m)Σₖ₌₁^{p}γₖ(c(j),c(h))Xₗ_{ₖ}_{(c(j),c(h))} (11).

If x is a typical media signal, X=W(x∘x) can often be approximated by a model with a small number of parameters. For example, by saving a few dominant entries of W(x∘x) and setting the rest to zero. Consequently, the covariances may be approximated by a parametric model with a small number of parameters. Therefore, the LR-SRM sensing matrix is structured; it produces correlated measurements and for DCT and DFT transforms, the standard deviations of the measurements are signal specific.

Random convolution SRM (RC-SRM) is another type of SRM, which is defined as follows: Let F be the complex DFT matrix, given by fₖⱼ [symbol] n^{-1/2}exp[−2πi(k−1)(j−1)/n)]. Note that indexing starts at 1 and FF*=I. Let B be a random diagonal matrix with diagonal elements bₖ [symbol] exp(iβₖ), 1≦k≦n where i [symbol] \sqrt{−1}, {βₖ|1≦k≦n/2+1} are independent, and

βₖ˜U({0,π}) [symbol] 2k [symbol] ₙ=2

βₖ˜U([0,2π)) 1<k<(n/2+1).

βₖ=2π−βₙ₊₂₋ₖ (n/2+1)<k≦n

where U(A) denotes uniform distribution on A. The RC-SRM follows the general definition of SRMs given in (7), with W=F* and R=BF. Accordingly, by (8) the mixture components are given by

z [symbol] F*RFx=F*(b∘(Fx))=n^{1/2}(F*b)*x

where b [symbol] [b₁, . . . , bₙ]^{T}. The mixture components of RC-SRMs are zero mean random variables with a covariance given by:

cov{zⱼ,zₕ}=m⁻¹ρₙ(j−h) (12)

where ρₙ(l), |l|<n is the circular autocorrelation of x:

ρₙ(l) [symbol] Σₖ₌₁ⁿxₖx [symbol] ₖ₊₁ [symbol] _{ₙ}, |l|<n.

In this case the variances of the mixture components, var{zⱼ}=cov{zⱼ,zⱼ}=m⁻¹ρ(0) are all the same. However, if the signal is correlated, as is generally the case with multimedia signals, the measurements are correlated as well.

The circular autocorrelation is the inverse DFT of the power spectrum of the signal. The power spectrum of the signal can be modeled with a small number of parameters, in a variety of ways, such as autoregressive (AR) models, or keeping the dominant values of the power spectrum and assuming that the rest are zero. Such a model defines an approximation to the autocorrelations ρₙ(l), |l|<n and therefore, by (12) also for the covariances of the measurements. Therefore, the RC-SRM sensing matrix is also structured, and the measurements it produces are correlated.

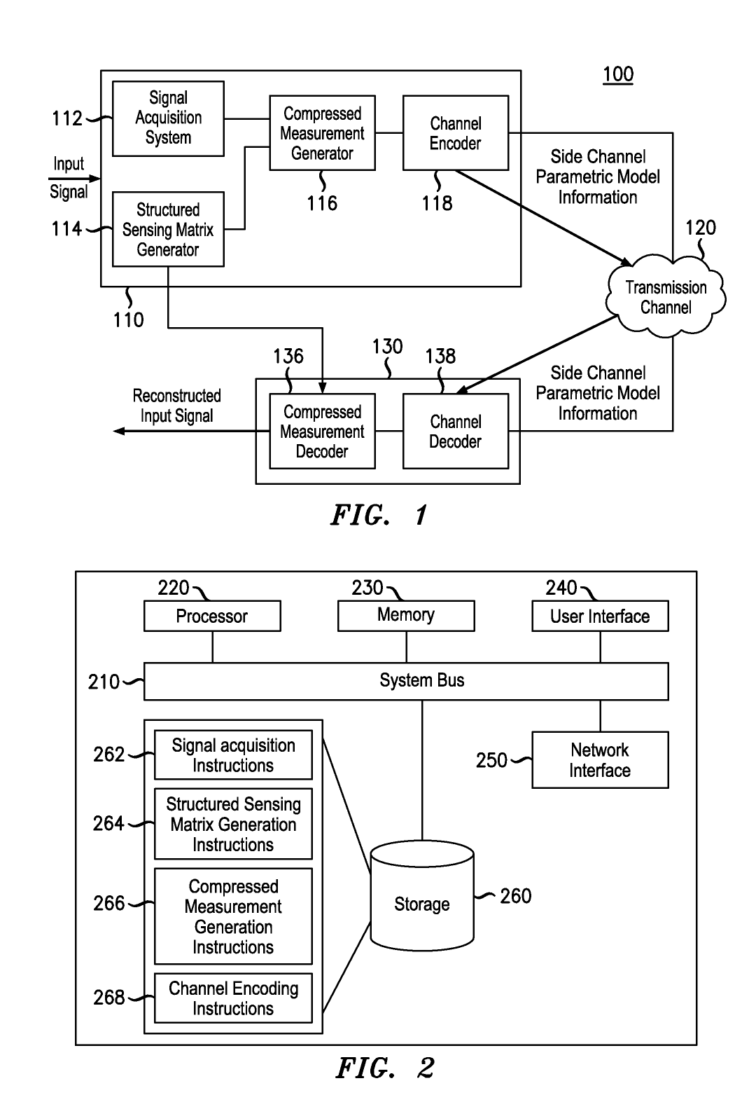

FIG. 1 illustrates a communication system using compressed measurements to transmit a signal. The communication system 100 includes at least one source device 110 for acquiring, encoding and/or transmitting signal data, a transmission channel 120, and at least one destination device 130 for receiving and decoding the received signal data. The transmission channel 120 may be any known transmission, wireless or wired channel. The channel 120 may also be a storage medium to which the source device 110 writes data and from which the device 130 reads data.

The source device 110 may be any type of device capable of acquiring signal data and encoding the signal data for transmission via the transmission channel 120. The source device 110 may include at least one processor and a memory for storing instructions to be carried out by the processor. The acquisition, encoding, transmitting or any other function of the source device 110 may be controlled by at least one processor. However, a number of separate processors may be provided to control a specific type of function or a number of functions of the source device 110. The implementation of the processor(s) to perform the functions described herein is within the skill of someone with ordinary skill in the art. Also, the various functions of the source device 110 may be implemented using specific hardware designed to carry out the function.

The destination device 130 may be any type of device capable of receiving, decoding and displaying signal data that may receive signal data from the network 120. The receiving and decoding or any other function of the destination device 130 may be controlled by at least one processor. However, a number of separate processors may be provided to control a specific type of function or a number of functions of the destination device 130. The implementation of the processor(s) to perform the functions described herein is within the skill of someone with ordinary skill in the art. Also, the various functions of the destination device 130 may be implemented using specific hardware designed to carry out the function.

The source device 110 may include a signal acquisition system 112, a structured sensing matrix generator 114, a compressed measurement generator 116, and a channel encoder 118. In addition, the source device 110 may include other components that are well known to one of ordinary skill in the art. The signal acquisition system 112 may acquire signal data from an input signal received by the source device 110. Also, the source device 110 may acquire signal data from any type of computer-readable medium such as optical disks and/or any type of memory storage unit. The acquisition of signal data may be accomplished according to any well known methods.

The compressed measurement generator 116 generates a set of measurements that represents the encoded signal data using compressed sensing. The acquired signal data may be represented by a vector having a plurality of signal values. For example, the compressed measurement generator 116 may receive a measurement matrix from the structured sensing matrix generator 114 and apply the structured sensing matrix to the signal data. It is also possible to combine the functionality of the signal acquisition system 112 and the compressed measurement generator 116 into one unit. Also, it is noted that the signal acquisition system 112, the structured sensing matrix generator 114, a compressed measurement generator 116, and a channel encoder 118 may be implemented in one, two or any number of units, including, but not limited to, units implemented as different node of a communication network. The compressed measurement generator 116 may operate to produce measurements as described in detail above.

The structured sensing matrix generator 114 may produce structured sensing matrices as described in detail above.

Using the set of measurements, the channel encoder 118 encodes the measurements to be transmitted in the communication channel. For example, the measurements may be quantized to integers as described above. Further, a linear predictor may be used as described in detail above to determine residuals based upon the measurements. These residuals may then be quantized and encoded for transmission. The encoded measurements may be packetized into transmission packets or transmitted in any other known communication method or protocol. Also, additional parity bits may be added to the packets for the purpose of error detection and/or error correction. It is well known in the art that the measurements thus coded may be transmitted in the transmission channel 120.

The destination device 130 may include a channel decoder 138 and a compressed measurement decoder 136. The destination device 130 may also include other components that are well known to one of ordinary skill in the art.

The channel decoder 138 may decode the data received from the transmission channel 120. For example, the data from the transmission channel 120 is processed to detect and/or correct errors from the transmission by using the parity bits of the data. The correctly received packets are unpacketized and decoded to produce the compressed measurements made in the compressed measurement generator 116. Further, error correction of the received packets may be carried out as is known in the art. Further, as described in great detail above, the channel decoder 138 may receive a parametric model and parametric data via a side channel from the channel encoder 118. The channel encoder 118 may produce a parametric model that describes operation of the channel encoder 118. This parametric model and may be used by the channel decoder 138 to decode the signal. Various embodiments of this are described in further detail above.

The compressed measurement decoder 136 reconstructs the signal data based on the correctly received set of measurements and the structured sensing matrix that was applied at the compressed measurement generator 116. The structured sensing matrix generator 114 may transmit the correlated sensing matrix to the compressed measurement decoder 136 via a side channel. However, the embodiments encompass any type of means for obtaining the measurement matrix at the destination device 130. Also, it is noted that the compressed measurement decoder 136 and the channel decoder 138 may be implemented in one or any number of units, including, but not limited to, units implemented as different node of a communication network.

FIG. 2 illustrates an exemplary hardware diagram 200 for implementing a source device, destination device, or any of the specific parts or groups of parts of either of these devices, for example, structured sensing matrix generator, channel encoder/decoder, etc. As shown, the device 200 includes a processor 220, memory 230, user interface 240, network interface 250, and storage 260 interconnected via one or more system buses 210. It will be understood that FIG. 2 constitutes, in some respects, an abstraction and that the actual organization of the components of the device 200 may be more complex than illustrated.

The processor 220 may be any hardware device capable of executing instructions stored in memory 230 or storage 260 or otherwise processing data. As such, the processor may include a microprocessor, field programmable gate array (FPGA), application-specific integrated circuit (ASIC), or other similar devices.

The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices.

The user interface 240 may include one or more devices for enabling communication with a user such as an administrator. For example, the user interface 240 may include a display, a mouse, and a keyboard for receiving user commands. In some embodiments, the user interface 240 may include a command line interface or graphical user interface that may be presented to a remote terminal via the network interface 250.

The network interface 250 may include one or more devices for enabling communication with other hardware devices. For example, the network interface 250 may include a network interface card (NIC) configured to communicate according to the Ethernet protocol. Additionally, the network interface 250 may implement a TCP/IP stack for communication according to the TCP/IP protocols. Various alternative or additional hardware or configurations for the network interface 250 will be apparent.

The storage 260 may include one or more machine-readable storage media such as read-only memory (ROM), random-access memory (RAM), magnetic disk storage media, optical storage media, flash-memory devices, or similar storage media. In various embodiments, the storage 260 may store instructions for execution by the processor 220 or data upon which the processor 220 may operate. For example, the storage 260 may store signal acquisition instructions 262, structured sensing matrix generation instructions 264, compressed measurement generation instructions 266, and channel encoding instructions 268. Also various combinations of these sets of instructions or additional instructions may be stored on the storage 260 depending on the functions implemented by the device 200.

It will be apparent that various information described as stored in the storage 260 may be additionally or alternatively stored in the memory 230. In this respect, the memory 230 may also be considered to constitute a “storage device” and the storage 260 may be considered a “memory.” Various other arrangements will be apparent. Further, the memory 230 and storage 260 may both be considered to be “non-transitory machine-readable media.” As used herein, the term “non-transitory” will be understood to exclude transitory signals but to include all forms of storage, including both volatile and non-volatile memories.

While the host device 200 is shown as including one of each described component, the various components may be duplicated in various embodiments. For example, the processor 220 may include multiple microprocessors that are configured to independently execute the methods described herein or are configured to perform steps or subroutines of the methods described herein such that the multiple processors cooperate to achieve the functionality described herein. Further, where the device 200 is implemented in a cloud computing system, the various hardware components may belong to separate physical systems. For example, the processor 220 may include a first processor in a first server and a second processor in a second server.

FIG. 3 illustrates method of encoding and transmitting compressed sensing measurements of a signal by a source device. The method 300 begins at 305. The method 300 then acquires a input signal 310. This acquisition may include receiving an analog signal and sampling the signal. It may also include receiving a digital signal and performing various processing on it. Next, the method 300 may generate a structured sensing matrix 315. This may be accomplished as described above in greater detail. The method 300 then may transmit a specification of the structured sensing matrix to the destination device 320. Next, the method 300 may generate compressed sensing measurements using the correlated sensing matrix and the input signal data 325 as described in greater detail above. Alternatively, the acquisition step 310 and the measurements generation step 325 may be merged by applying the structured sensing matrix to the analog signal by way of analog computation, obtaining an analog measurements signal and sampling the measurements signal to obtain the compressed sensing residual. After the measurements are generated, a parametric model for the measurement statistics is created, 330. Next the method may quantize the measurements 335 and then it may channel encode the quantization codewords 340 as described above. As part of the encoding of the compresses sensing measurements, the source device may generate a parametric model that describes the channel encoding of the compressed sensing measurements. This parametric model and parametric data may be transmitted to the destination device 345 using as side information as described above. Finally, the method transmits the encoded compressed sensing measurements 350. The method then ends at 355.

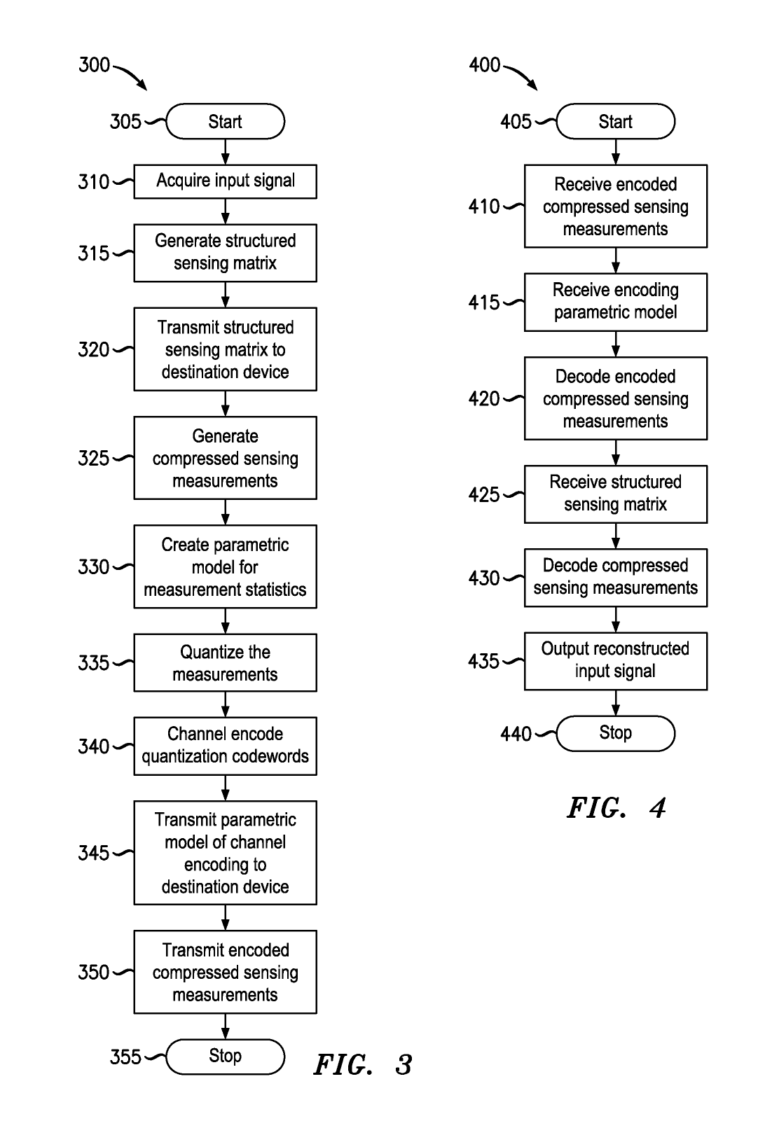

FIG. 4 illustrates method of receiving and reconstructing compressed sensing measurements of a signal by a destination device. The method 400 begins at 405. The method 400 then receives the encoded compressed sensing measurements 410 from the source device via a transmission channel. Next, the method 400 may receive the encoding parametric model 415 from the source device. The method 400 then may decode the encoded compressed sensing measurements 420, using the parametric model, as described in great detail above. Next, the method 400 may receive the correlated sensing matrix 425 from the source device. The method 400 then may decode the compressed sensing measurements 430, which may include channel decoding and unquantizing. This may be accomplished as described in great detail above. Finally, the source device may then output the reconstructed input signal 435. The method then ends at 440.

In the methods 300 and 400 described above it is noted that various steps may be performed in different orders depending upon the need of one step for data from another step.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A non-transitory machine-readable storage medium encoded with instructions for execution by a source device for compressive sensing a signal, wherein the source device acquires a set of compressive sensing measurements using a structured sensing matrix, the non-transitory machine-readable medium comprising:
instructions for determining a signal specific coding scheme for the set of compressive sensing measurements;
instructions for coding the compressed sensing measurements using the determined signal specific coding scheme; and
instructions for determining a parametric model describing the signal specific coding scheme for the encoded set of compressed sensing measurements.

2. The non-transitory machine-readable storage medium of claim 1, further comprising instructions for transmitting a description of the parametric model via a communications channel.

3. The non-transitory machine-readable storage medium of claim 1, wherein the signal specific coding scheme is not identical for all the measurements in the set of compressive sensing measurements.

4. The non-transitory machine-readable storage medium of claim 1, wherein the coding scheme includes quantizing the compressed sensing measurements.

5. The non-transitory machine-readable storage medium of claim 4, wherein the quantizing of the compressive sensing measurements is done differently for different subsets of the set of compressive sensing measurements.

6. The non-transitory machine-readable storage medium of claim 1, wherein the coding scheme includes using a prediction of at least one compressed sensing measurement and a residual to describe the compressed sensing measurements.

7. The non-transitory machine-readable storage medium of claim 6, wherein the description of the parametric model includes a description of the prediction coefficients.

8. The non-transitory machine-readable storage medium of claim 1, wherein determining a signal specific coding scheme for the set of compressed sensing measurements further includes:
instructions for computing prediction coefficients for the at least one measurement based upon statistical properties of the signal;
wherein the parametric model describing the signal specific coding scheme determines the prediction coefficients.

9. The non-transitory machine-readable storage medium of claim 6, wherein the coding the compressed sensing measurements using the determined signal specific coding scheme includes coding of a prediction residual for at least one measurement.

10. A non-transitory machine-readable storage medium encoded with instructions for execution by a destination device for decoding compressive sensing measurements, the non-transitory machine-readable medium comprising:
instructions for receiving a set of encoded compressive sensing measurements of the signal;
instructions for receiving a parametric model describing a signal specific coding scheme for the encoded set of compressed sensing measurements; and
instructions for decoding the compressed sensing measurements using the signal specific coding scheme described by the received parametric model.

11. The non-transitory machine-readable storage medium of claim 10, further including:
instructions for reconstructing a signal from the decoded compressive sensing measurements.

12. The non-transitory machine-readable storage medium of claim 10, wherein the signal specific coding scheme is not identical for all the measurements in the set of compressive sensing measurements.

13. The non-transitory machine-readable storage medium of claim 10, wherein the set of encoded compressive sensing measurements includes codewords of quantized compressive sensing measurements.

14. The non-transitory machine-readable storage medium of claim 10, wherein the coding scheme includes using a prediction of at least one compressed sensing measurement.

15. The non-transitory machine-readable storage medium of claim 14, wherein the set of encoded compressive sensing measurements measurement includes a prediction residual.

16. A source device comprising:
a memory device; and
a processor in communication with the memory device, the processor being configured to:
acquire a set of compressive sensing measurements of the signal using a structured sensing matrix;
determine a signal specific coding scheme for the set of compressive sensing measurements;
code the compressed sensing measurements using the determined signal specific coding scheme; and
determine a parametric model describing the signal specific coding scheme for the encoded set of compressed sensing measurements.

17. The source device of claim 16, wherein the processor is further configured to transmit a description of the parametric model via a communications channel.

18. The source device of claim 16, wherein the signal specific coding scheme is not identical for all the measurements in the set of compressive sensing measurements.

19. The source device of claim 16, wherein the coding scheme includes quantizing the compressed sensing measurements.

20. The source device of claim 19, wherein the quantizing of the compressive sensing measurements is done differently for different subsets of the set of compressive sensing measurements, based upon the statistical properties of the compressive sensing measurements.

21. The source device of claim 16, wherein the coding scheme includes using a prediction of at least one compressed sensing measurement and a residual to describe the compressed sensing measurements.

22. The source device of claim 21, wherein the description of the parametric model includes a description of the prediction coefficients.

23. The source device of claim 16, wherein determining a signal specific coding scheme for the set of compressed sensing measurements further includes:
computing prediction coefficients for the at least one measurement based upon statistical properties of the signal;
wherein the parametric model describing the signal specific coding scheme determines the prediction coefficients.

24. The source device of claim 23, wherein the coding the compressed sensing measurements using the determined signal specific coding scheme including coding of a prediction residual for at least one measurement.

25. A destination device comprising:
a memory device; and
a processor in communication with the memory device, the processor being configured to:
receive an encoded set of compressive sensing measurements of the signal;
receive a parametric model describing a signal specific coding scheme for the encoded set of compressed sensing measurements; and
decode the compressed sensing measurements using the signal specific coding scheme described by the received parametric model.

26. The destination device of claim 25, further including the step of:
reconstructing a signal from the decoded compressive sensing measurements.

27. The destination device of claim 25, wherein the signal specific coding scheme is not identical for all the measurements in the set of compressive sensing measurements.

28. The destination device of claim 25, wherein the encoded set of compressive sensing measurements includes codewords of quantized compressive sensing measurements.

29. The destination device of claim 25, wherein the coding scheme includes using a prediction of at least one compressed sensing measurement.

30. The destination device of claim 29, wherein the encoded set of compressive sensing measurements measurement includes a prediction residual.
